(19) United States
(12) Patent Application Publication
(10) Pub. No.: US 2024/0187291 A1
(43) Pub. Date: Jun. 6, 2024

(54) ENHANCED PHASE TRACKING REFERENCE SIGNAL BASED ON CHIRP SEQUENCES

(71) Applicant: TOYOTA JIDOSHA KABUSHIKI KAISHA, Toyota-shi Aichi (JP)

(72) Inventor: Andreas FALKENBERG, Escondido, CA (US)

(73) Assignee: Toyota Jidosha Kabushiki Kaisha, Toyota-shi, Aichi-ken (JP)

(21) Appl. No.: 18/550,582

(22) PCT Filed: Mar. 14, 2022
(86) PCT No.: PCT/US2022/020195

§ 371 Date: Sep. 14, 2023

Related U.S. Application Data
(60) Provisional application No. 63/161,513, filed on Mar. 16, 2021.

(51) Int. Cl. H04L 27/10; H04L 27/26

(52) U.S. Cl. CPC H04L 27/103; H04L 27/2613; H04L 27/26412

(57) ABSTRACT

A method for phase tracking reference signal (PT-RS) signals transmission includes receiving, by a user equipment (UE) from a base station (BS), one or more messages comprising uplink PT-RS configuration parameters and transmitting, by the UE to the BS, PT-RS signals via radio resources of a physical uplink shared channel (PUSCH). The transmitting is based on: the uplink PT-RS configuration parameters, a PT-RS sequence generation process for generating a PT-RS sequence, wherein the PT-RS sequence is based, on a, chirp signal with a time-varying frequency according to a chirp factor and an PT-RS mapping process for mapping the generated PT-RS sequence to the radio resources of the PUSCH.

### CROSS-REFERENCE TO RELATED APPLICATIONS

This application is a § 371 national phase of PCT/US2022/020195, filed Mar. 14, 2022, which claims priority under 35 USC § 119(e) from U.S. Provisional Patent Application No. 63/161,513, filed on Mar. 16, 2021, each of which is incorporated herein by reference.

### BACKGROUND OF THE INVENTION

The present invention is directed to 5G, which is the 5th generation mobile network. It is a new global wireless standard after 1G, 2G, 3G, and 4G networks. 5G enables networks designed to connect machines, objects and devices.

The invention provides various capabilities for addressing phase tracking error in 5G wireless networks, for example, small frequency discrepancies which may lead to delays between transmitter and receiver signals. In some examples, phase differences may occur because clocks of remote devices are not perfectly aligned. Even small differences in the frequency may translate into phases offsets, which may lead to higher bit error rates. In an inventive system, a receiver may implement processes to counter phase differences, for example, by enhancing phase tracking reference signal (PT-RS) signal generation in downlink, uplink and sidelink communications by utilizing a chirp signal, and by enhancing the phase tracking performance at the user equipment (UE) or base station.

### SUMMARY OF THE INVENTION

In an embodiment, the invention provides a method for phase tracking reference signal (PT-RS) signals transmission that includes receiving, by a user equipment (UE) from a base station (BS), one or more messages comprising uplink PT-RS configuration parameters; and transmitting, by the UE to the BS, PT-RS signals via radio resources of a physical uplink shared channel (PUSCH) based on: the uplink PT-RS configuration parameters and a PT-RS sequence generation process for generating a PT-RS sequence, wherein the PT-RS sequence is based on a chirp signal with a time-varying frequency according to a chirp factor; and a PT-RS mapping process for mapping the generated PT-RS sequence to the radio resources of the PUSCH. The uplink phase tracking reference signal (PT-RS) configuration parameters may be a first parameter defining the chirp factor, where the chirp factor may be a predetermined value.

The method may further include receiving a downlink control information (DCI) comprising a field with a value defining the chirp factor, and/or receiving a medium access control (MAC) control element (CE) defining the chirp factor. Moreover, the one or more received messages may include a phase tracking reference signal (PT-RS) uplink config information element defining the uplink PT-RS configuration parameters.

The uplink phase tracking reference signal (PT-RS) configuration parameters may embody a frequency density parameter that defines a presence and frequency density of the PT-RS as a function of a scheduled bandwidth of the physical uplink shared channel (PUSCH), may embody a parameter defining a maximum number of uplink PT-RS ports, may embody a parameter indicating an uplink PT-RS boosting factor per PT-RS port, may embody a resource element offset parameter defining a subcarrier offset for uplink PT-RS, and may embody a sample density parameter defining sample density of PT-RS for discrete frequency transform (DFT) spread orthogonal frequency division multiplexing (OFDM), pre-DFT, defining a set of thresholds that indicate dependency between presence of PT-RS and scheduled bandwidth of the physical uplink shared channel (PUSCH).

The uplink phase tracking reference signal (PT-RS) configuration parameters may embody a time density parameter defining a presence and time density of the PT-RS as a function of modulation and coding scheme (MCS), may embody a time density transform precoding parameter defining a time density of PT-RS for discrete frequency transform spread orthogonal frequency division multiplexing (DFT-s-OFDM) in an OFDM symbol level and may embody one or more parameters defining whether the uplink PT-RS is configured with a cyclic prefix orthogonal frequency division multiplexing (CP-OFDM) waveform or a discrete frequency transform spread orthogonal frequency division multiplexing (DFT-s-OFDM) waveform. The phase tracking reference signal (PT-RS) signals may be used for compensation of an oscillator phase noise. The radio resources of the physical uplink shared channel (PUSCH) can be associated with a cell in frequency range 2 (FR2).

The method for phase tracking reference signal (PT-RS) signals transmission may include receiving a downlink control information (DCI) comprising an uplink grant defining the radio resources of the physical uplink shared channel (PUSCH) for transmission of an uplink transport block. In one form, the downlink control information (DCI) is one of DCI format 0_0, DCI format 0_1 and DCI format 0_2. In one form, a first density of the PT-RS signals in the frequency domain is sparser than a second density of the PTR-RS signals in the time domain. For that matter, in the invention, the phase tracking reference signal (PT-RS) sequence generation process includes generating the PT-RS sequence based on a first process if transform precoding is not enabled and based on a second process if transform precoding is enabled, and/or generating values of the PT-RS sequence for different subcarriers that the PT-RS sequence is mapped to and/or mapping the generated PT-RS sequence to different resource elements within the radio resources of a physical uplink shared channel (PUSCH).

In an embodiment, the invention provides a method of phase tracking reference signal (PT-RS) signals reception including receiving, by a user equipment (UE) from a base station (BS), one or more messages comprising downlink PT-RS configuration parameters; and receiving, by the UE from the BS, PT-RS signals via radio resources of a physical downlink shared channel (PDSCH) based on: the downlink PT-RS configuration parameters, a PT-RS sequence generation process for generating a PT-RS sequence, wherein the PT-RS sequence is based on a chirp signal with a time-varying frequency according to a chirp factor, and a PT-RS mapping process for mapping the generated PT-RS sequence to the radio resources of the PDSCH. The downlink phase tracking reference signal (PT-RS) configuration parameters comprise a first parameter defining the chirp factor, wherein the chirp factor preferably is a predetermined value.

The method may include receiving a downlink control information (DCI) comprising a field with a value defining the chirp factor, and/or receiving a medium access control (MAC) control element (CE) defining the chirp factor. The one or more messages may include a phase tracking reference signal (PT-RS) PT-RS downlink config information element indicating the PT-RS configuration parameters.

The downlink phase tracking reference signal (PT-RS) configuration parameters may embody an energy per resource element (EPRE) ratio parameter defining an EPRE ratio between the PT-RS and the physical downlink shared channel (PDSCH), may embody a frequency density parameter defining presence and frequency density of the PT-RS as a function of scheduled bandwidth of the physical downlink shared channel (PDSCH), may embody a parameter indicating maximum number of downlink PT-RS ports, may embody a resource element offset parameter indicating a subcarrier offset for downlink PT-RS, and may embody a time density parameter defining a presence and time density of downlink PT-RS as a function of MCS.

The method may include compensating for an oscillator phase noise based on the received phase tracking reference signal (PT-RS) signals. Preferably, the radio resources of the physical downlink shared channel (PDSCH) are associated with a cell in frequency range 2 (FR2). Also, the method may include performing, based on the received phase tracking reference signal (PT-RS) signals, at least one of: time and frequency tracking, estimation of a delay spread and estimation of a Doppler spread, and alternatively, may include receiving a downlink control information (DCI) comprising a downlink assignment defining the radio resources of the physical downlink shared channel (PDSCH) for reception of a downlink transport block.

Preferably, the downlink control information (DCI) is one of DCI format 1_0, DCI format 1_1 and DCI format 1_2. A first density of the PT-RS signals in the frequency domain preferably is sparser than a second density of the PTR-RS signals in the time domain. The phase tracking reference signal (PT-RS) sequence generation process includes generating values of the PT-RS sequence for different subcarriers that the PT-RS sequence is mapped to. The phase tracking reference signal (PT-RS) mapping process includes mapping the generated PT-RS sequence to different resource elements within the radio resources of a physical downlink shared channel (PDSCH).

In an embodiment, the invention provides a method of phase tracking reference signal (PT-RS) signals transmission that includes receiving, by a first user equipment (UE) from a base station, one or more messages comprising sidelink PT-RS configuration parameters; and transmitting, by the first UE to a second UE, PT-RS signals via radio resources of a physical sidelink shared channel (PSSCH) based on: the sidelink PT-RS configuration parameters, a PT-RS sequence generation process for generating a PT-RS sequence, wherein the PT-RS sequence is based on a chirp signal with a time-varying frequency according to a chirp factor and a PT-RS mapping process for mapping the generated PT-RS sequence to the radio resources of the PSSCH. The sidelink phase tracking reference signal (PT-RS) configuration parameters includes a first parameter defining the chirp factor, wherein the chirp factor is a predetermined value.

The method may include receiving a downlink control information comprising a field with a value defining the chirp factor, and/or receiving a medium access control (MAC) control element (CE) indicating the chirp factor. For that matter, the one or more messages may embody a phase tracking reference signal (PT-RS) sidelink config information element defining the sidelink PT-RS configuration parameters. And the sidelink phase tracking reference signal (PT-RS) configuration parameters may embody a frequency density parameter defining a presence and frequency density of the PT-RS as a function of scheduled bandwidth of the physical sidelink shared channel (PSSCH), may embody a resource element offset parameter indicating a subcarrier offset for sidelink PT-RS and/or may embody a time density parameter defining a presence and time density of sidelink PT-RS as a function of MCS.

The phase tracking reference signal (PT-RS) signals may be used

for compensating an oscillator phase noise by the second user equipment (UE). The phase tracking reference signal (PT-RS) signals may be used for at least one of: time and frequency tracking, estimation of a delay spread and estimation of a doppler spread.

The method may further include receiving a downlink control information (DCI) comprising sidelink scheduling parameters indicating the radio resources of the physical downlink shared channel (PSSCH) for transmission of a sidelink transport block. The downlink control information (DCI) is one of a DCI format 3_0 and DCI format 3_1. A first density of the PT-RS signals in the frequency domain is sparser than a second density of the PTR-RS signals in the time domain. The phase tracking reference signal (PT-RS) sequence generation process may include generating values of the PT-RS sequence for different subcarriers that the PT-RS sequence is mapped, where the phase tracking reference signal (PT-RS) mapping process may include mapping the generated PT-RS sequence to different resource elements within the radio resources of a physical sidelink shared channel (PSSCH).

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16 shows an example Phase Tracking Reference Signal structure in time domain according to some aspects of some of various exemplary embodiments of the present disclosure.

FIG. 17 shows an example Phase Tracking Reference Signal (PT-RS) structure in frequency domain according to some aspects of some of various exemplary embodiments of the present disclosure.

FIG. 18 shows an example chirp signal with time-varying frequency according to some aspects of some of various exemplary embodiments of the present disclosure.

FIG. 19 shows an example uplink PT-RS transmission process according to some aspects of some of various exemplary embodiments of the present disclosure.

FIG. 20 shows an example downlink PT-RS reception process according to some aspects of some of various exemplary embodiments of the present disclosure.

FIG. 21 shows an example sidelink PT-RS transmission process according to some aspects of some of various exemplary embodiments of the present disclosure.

### DETAILED DESCRIPTION OF THE INVENTION

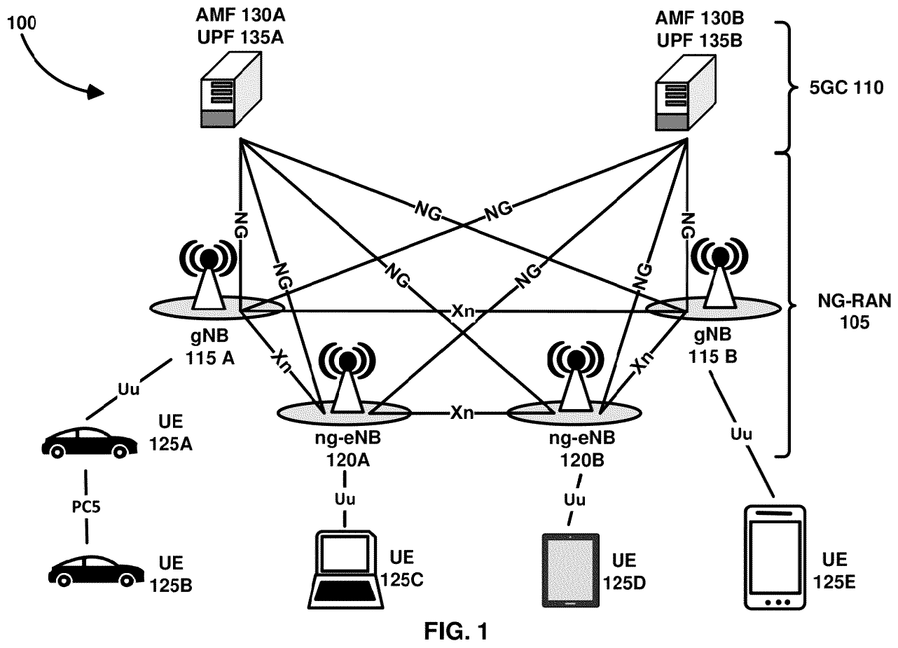

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Example of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport IP layer, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that originates sidelink communication frames. The Destination Layer-2 ID may be a link-layer identity that identifies a device that are recipients of sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

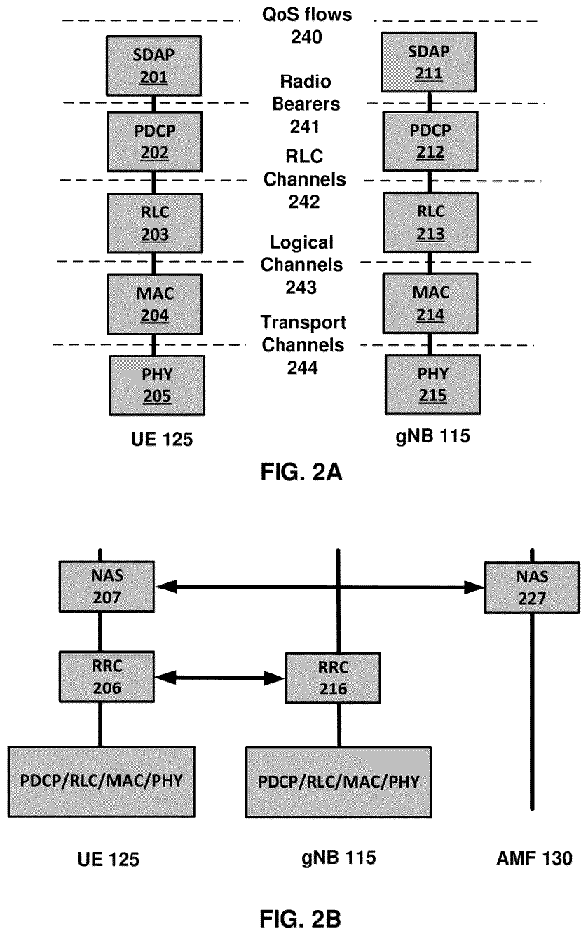

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or more different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBS.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

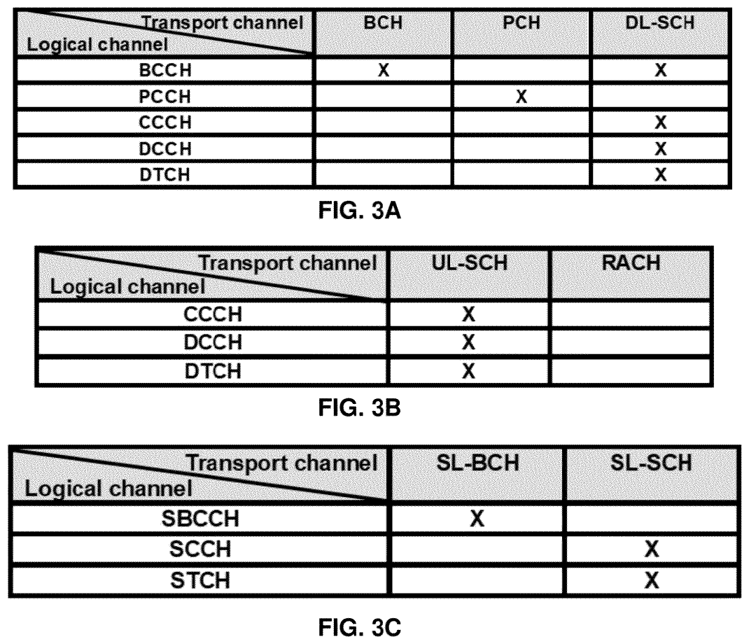

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL- SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

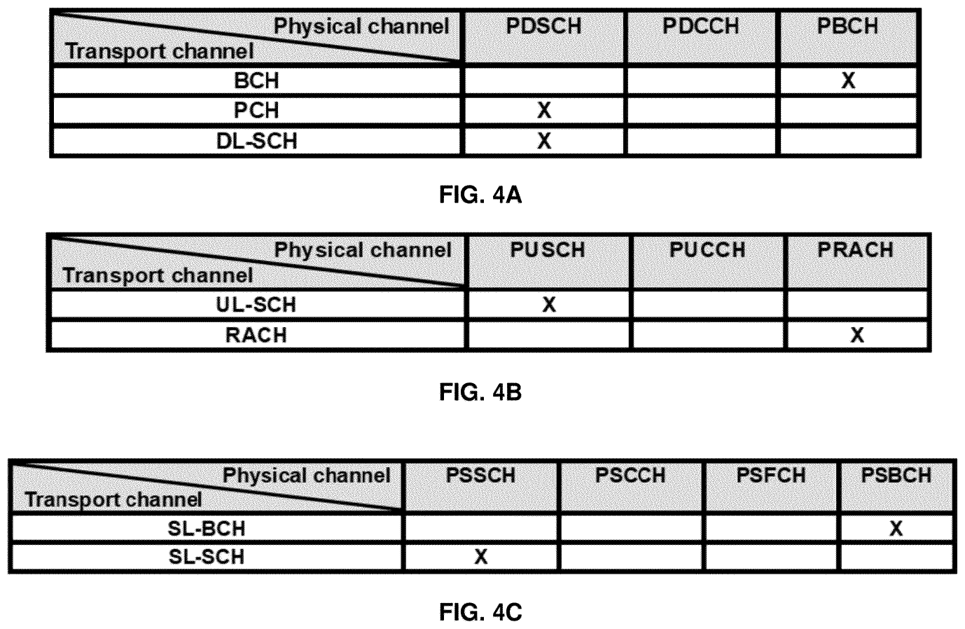

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

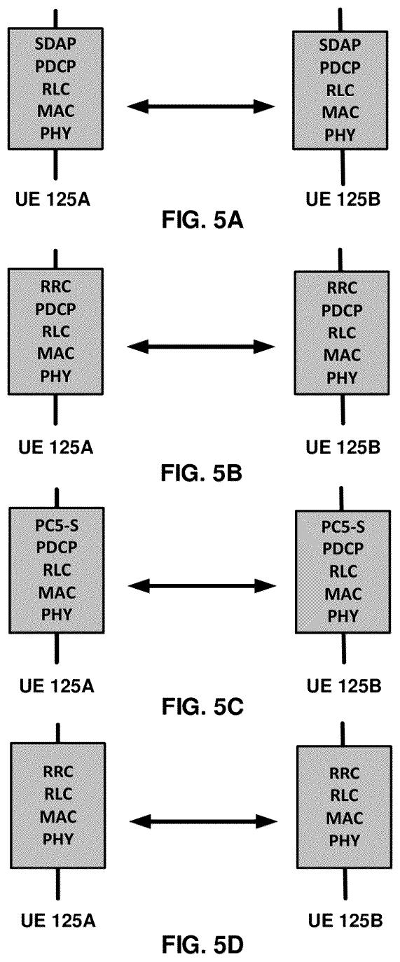

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

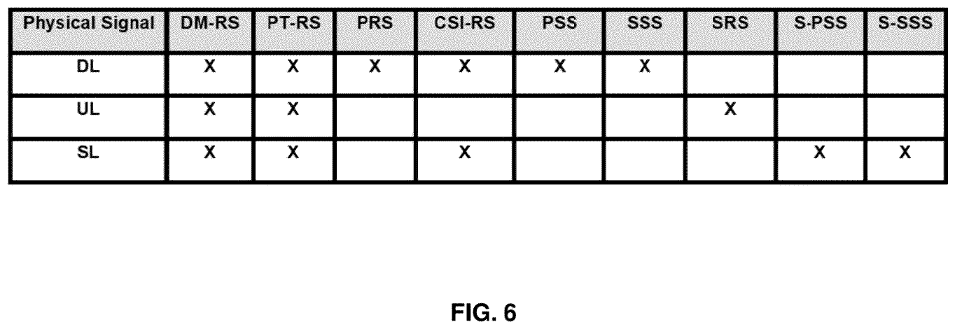

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

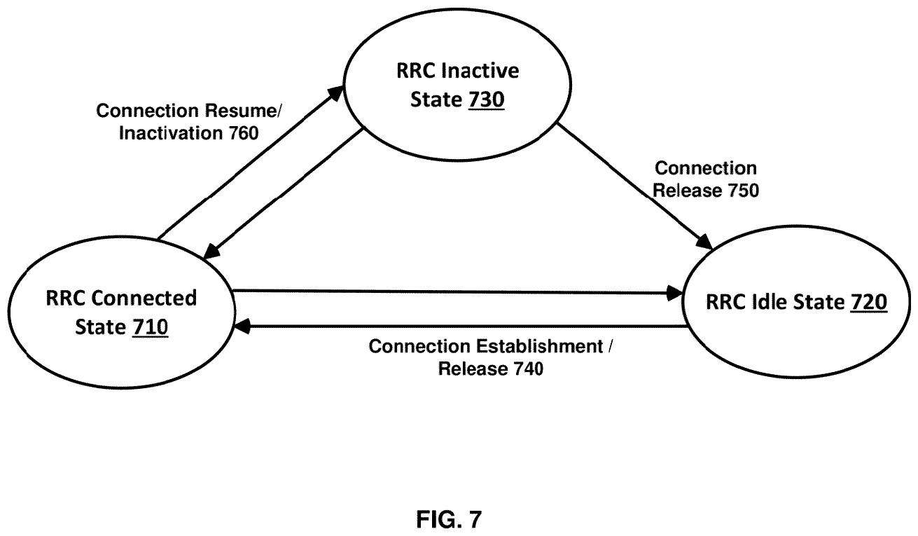

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

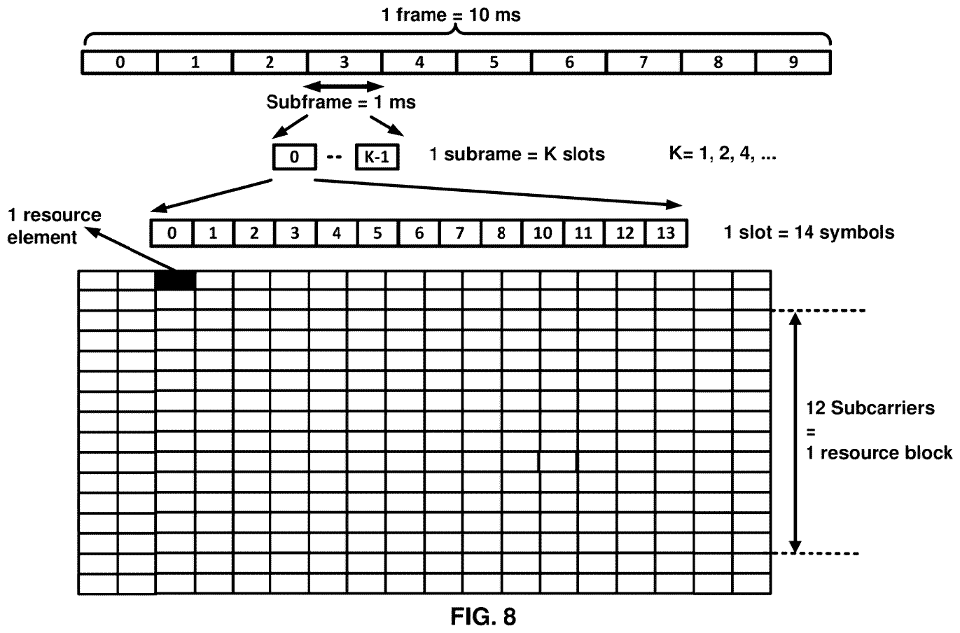

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend of the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

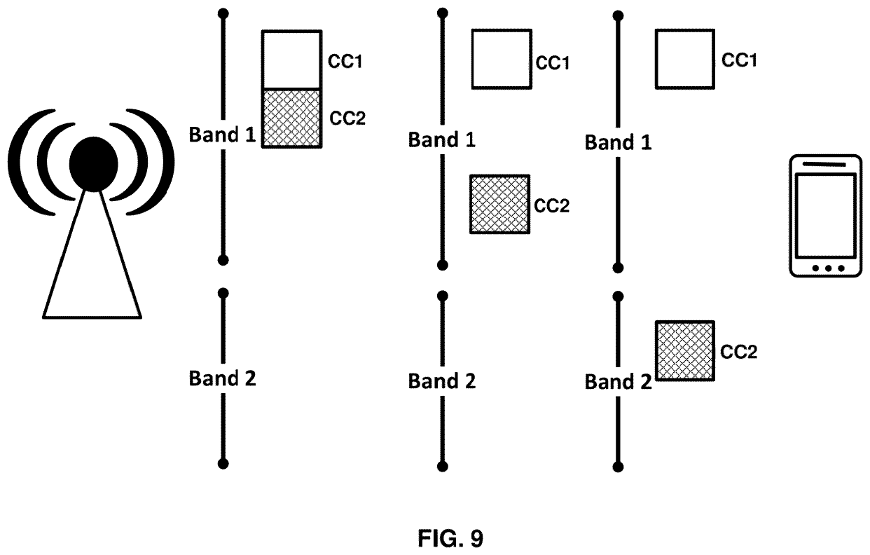

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

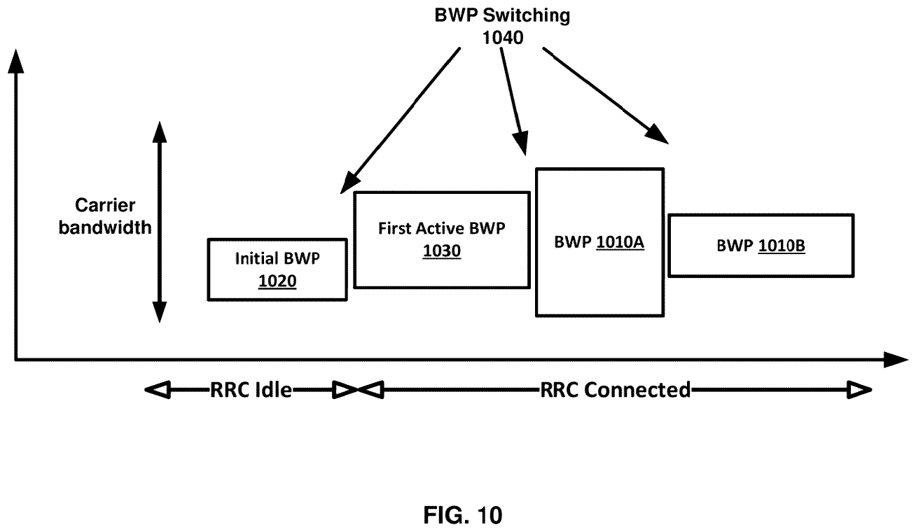

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

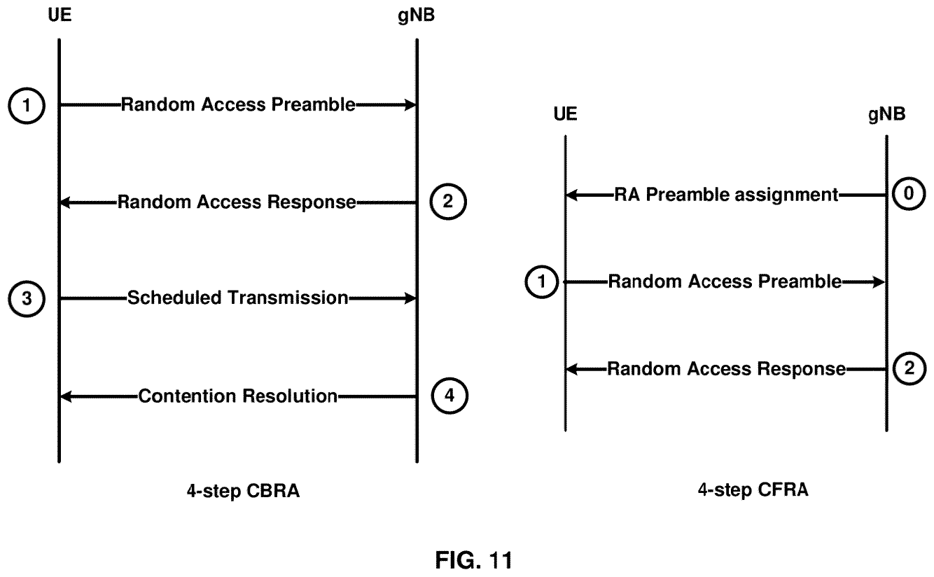

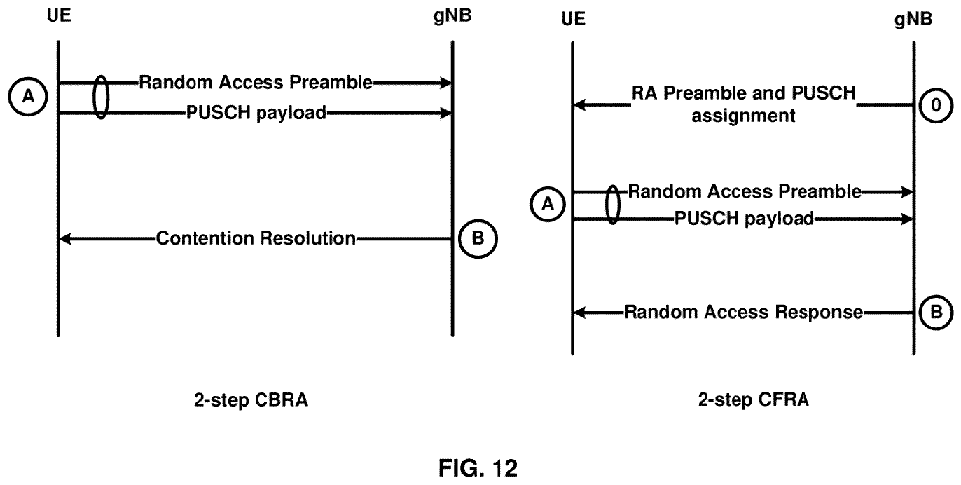

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

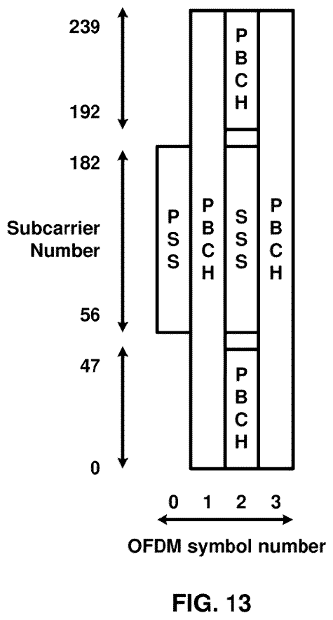

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e. using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

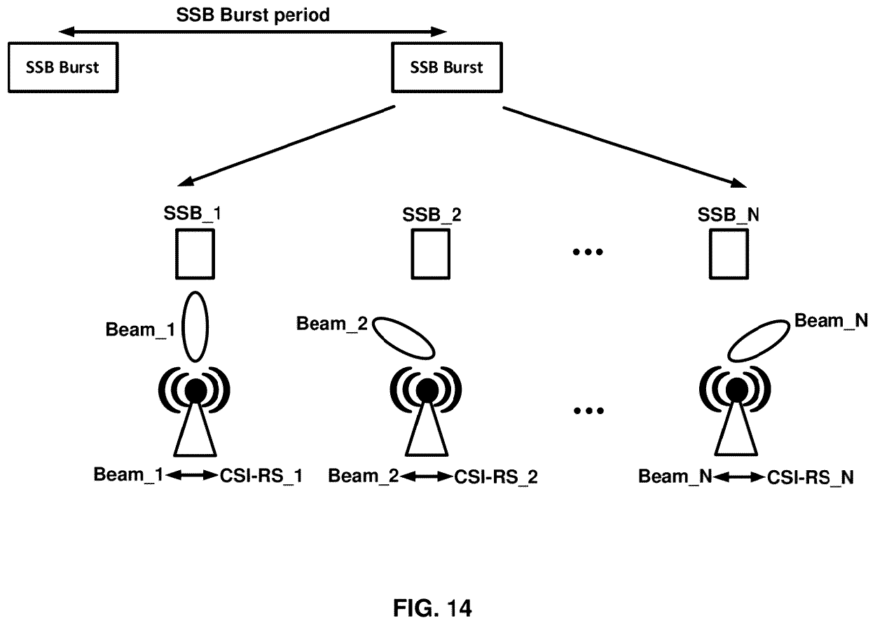

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depends on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

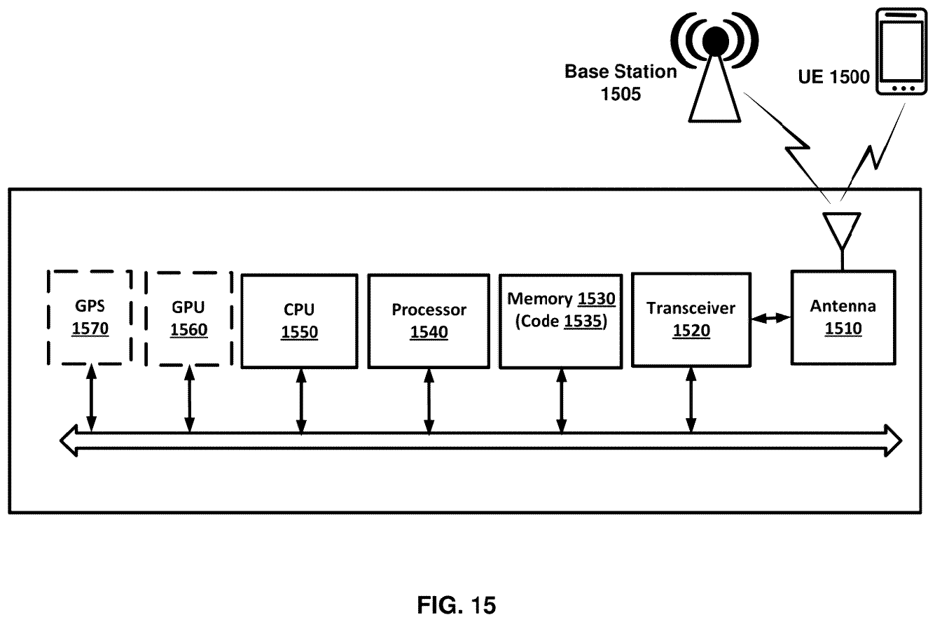

FIG. 15 shows example components of a user equipment and a base station for transmission and/or reception according to some aspects of some of various exemplary embodiments of the present disclosure. All or a subset of blocks and functions in FIG. 15 may be in the base station 1505 and the user equipment 1500 and may be performed by the user equipment 1500 and by the base station 1505. The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples and depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In some examples, a Phase Tracking Reference Signal (PT-RS) may be used to enable compensation of oscillator phase noise in a frequency range/band (e.g., FR1 or FR2 or above-6GHz frequency bands). The phase noise may increase as a function of carrier frequency. The PT-RS may be utilized at high frequency (e.g., mmWave bands) to mitigate the phase noise effect. In the case of OFDM signals, the effect of phase noise may be phase rotation of subcarriers, known as common phase error (CPE).

In some example, the PT-RS may be designed to have low density in the frequency domain and high density in time domain. In some examples, the phase rotation cause by CPE may be similar for subcarriers within an OFDM symbol and may have minimal correlation across OFDM symbols.

In some examples, the PT-RS may be UE-specific and may be confined in scheduled resources (e.g., scheduled resources for transmission of a transport block via PDSCH, PUSCH or PSSCH). In some examples, the PT-RS may be beamformed. In some examples, the number of PT-RS ports may be lower than total number of ports and orthogonality between PT-RS ports may be achieved by means of frequency division multiplexing. The PT-RS may be configurable depending on the quality of oscillators, carrier frequency, OFDM subcarrier spacing and modulation and coding scheme (MCS) used for transmission.

In some example, the PT-RS may be used for time and frequency tracking and/or estimation of delay spread and/or Doppler spread at the UE side. The PT-RS signals may be transmitted within a confined bandwidth for a configurable time duration controlled by the RRC parameters.

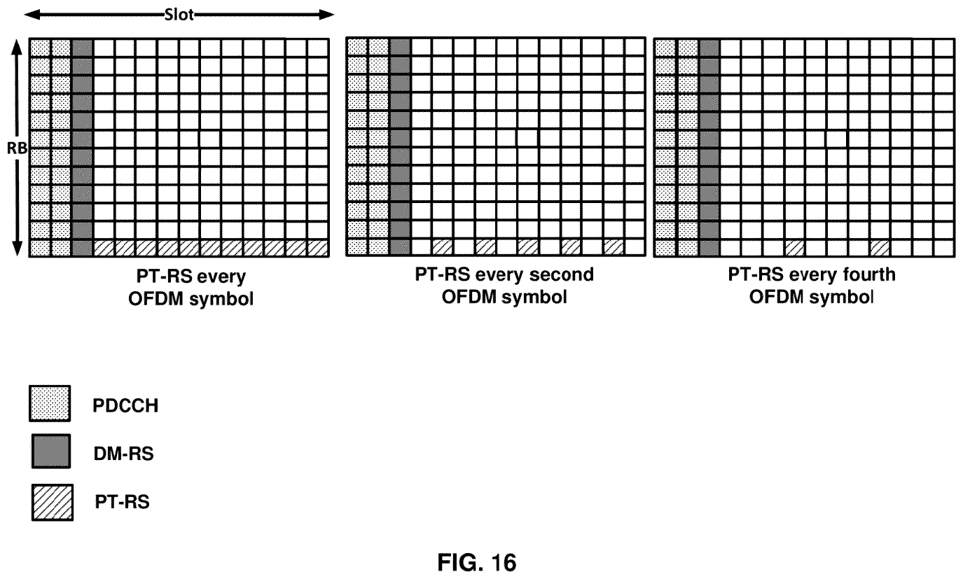

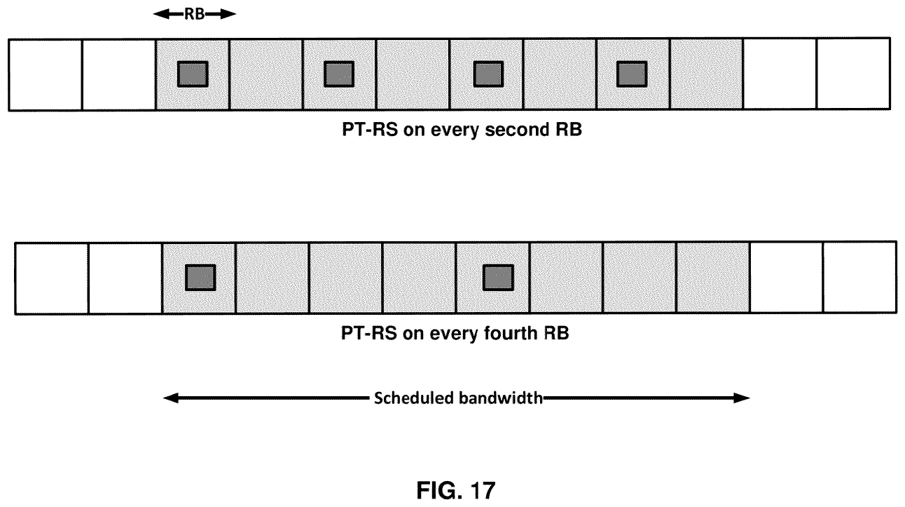

In some examples, the time-frequency structure of the PT-RS may depend on the waveform. Example time-domain structure and frequency domain structure of PT-RS are shown in FIG. 16 and FIG. 17 respectively. For OFDM, the first reference symbol (e.g., prior to applying an orthogonal sequence) in a PDSCH/PUSCH allocation may be repeated every {1, 2, 4} symbol starting with the first OFDM symbol in the allocation (e.g., PDSCH/PUSCH/PSSCH allocation). The repetition counter may be reset at a DM-RS occasion and there may be no need for PT-RS transmission immediately following a DM-RS occasion. In some examples, in the frequency domain, PT-RS may be transmitted in every second or fourth resource block, resulting in a sparser frequency domain structure. The density in the frequency domain may be dependent on the scheduled bandwidth. In some examples, to reduce risk of collision between PT-RS signals associated with different devices scheduled on overlapping frequency-domain resources, the subcarrier number and the resource blocks used for PT-RS transmission may be determined based on a radio network temporary identifier (e.g., C-RNTI) associated with the device.

In some examples, different sequence generation and resource mapping processes may be used for transmission of PT-RS via PDSCH, PUSCH or PSSCH.

In some examples and for Phase-tracking reference signals used for transmission via PUSCH, different processes may be used depending on whether transform precoding is enabled or not. If transform precoding is not enabled, a first PT-RS sequence generation process may be used. The precoded phase-tracking reference signal for subcarrier k on layer j may be given by

$${r}^{( {\tilde{p}}_{j} )} ( m ) = \{ \begin{matrix}r ( m ) & if j = {j}^{′} or j = {j}^{″} \\ 0 & otherwise\end{matrix}$$

wherein antenna ports \tilde{p}_{j′} or {\tilde{p}_{j′}, \tilde{p}_{j″} } are associated with PT-RS transmission, r^{(m)} is determined based on a chirp signal described in more detail below. If transform precoding is enabled, a second PT-RS sequence generation process may be used. The UE may use one or more mapping processes (e.g., based on whether transform precoding is enabled or not) to map the generated PT-RS sequence to resource blocks used for PUSCH.

In an example and to demonstrate the use of chirp signal for PT-RS sequence generation, a subcarrier spacing of 60 KHz may be used which translates to a symbol time of 16.67 us. The chirp formula may be based on Ae^{-j(ω}^{₀}^{+δt)t}. One chirp symbol may be the signal from t=0 to t=tₘₐₓ where tₘₐₓ=16.67 us. In an example with a chirp ram from 1 MHz to 2 MHz, we have f₀=ω₀/2π=1.0 MHz. The target frequency may be fₘₐₓ=f₀+δtₘₐₓ/(2π)=2.0 Mhz which leads to δ=377132000000.77.

In some examples, if transform precoding is not enabled, the PUSCH PT-RS may be mapped to resource elements according to

$$[ \begin{matrix}{a}_{k , l}^{( {p}_{o} , μ )} \\ ⋮ \\ {a}_{k , l}^{( {p}_{ρ - 1} , μ )}\end{matrix} ] = {β}_{PT - RS} W [ \begin{matrix}{r}^{( {\tilde{p}}_{0} )} ( 2 n + {k}^{′} ) \\ ⋮ \\ {r}^{( {\tilde{p}}_{v - 1} )} ( 2 n + {k}^{′} )\end{matrix} ] \\ k = \{ \begin{matrix}4 n + 2 {k}^{′} + Δ & configuration type 1 \\ 6 n + {k}^{′} + Δ & configuration type 2\end{matrix}$$

when all the following conditions are fulfilled
l is within the OFDM symbols allocated for the PUSCH transmission
resource element (k,l) is not used for DM-RS
k′ and Δ correspond to \tilde{p}₀, . . . , \tilde{p}ᵥ₋₁

The quantities k′ and Δ may be given based on predetermined tables and the configuration type may be given by the higher-layer parameter DMRS-UplinkConfig. The precoding matrix W may be a predetermined matrix. The quantity β_{PTRS} may be an amplitude scaling factor to conform with the transmit power. In some examples, a different mapping process may be used if transform precoding is enabled.

In some examples and for Phase-tracking reference signals used for transmission via PDSCH, for subcarrier k, a sequence based on a chirp signal may be used. More details on the chip signal is given below. The UE may assume phase-tracking reference signals are present only in the resource blocks used for the PDSCH. If present, the UE may assume the PDSCH PT-RS is scaled by a factor β_{PT-RS,i} to conform with the transmission power and mapped to resource elements (k, l)_{p,μ} according to α_{k,l}^{(p,μ)}=β_{PT-RS,i} when all the following conditions are fulfilled:
l is within the OFDM symbols allocated for the PDSCH transmission
resource element (k, l)_{p,μ} is not used for DM-RS, non-zero-power CSI-RS (except for those configured for mobility measurements or with resourceType in corresponding CSI-ResourceConfig configured as ‘aperiodic’), zero-power CSI-RS, SS/PBCH block, a detected PDCCH, or is declared as ‘not available’.

The set of time indices I defined relative to the start of the PDSCH allocation may be defined based on a process.

In some examples and for Phase-tracking reference signals used for transmission via PSSCH, the precoded sidelink phase-tracking reference signal for subcarrier k on layer j may be given by r^{(\tilde{p}}^{ⱼ₎}(m)=

$$\{ \begin{matrix}r ( m ) & if j = {j}^{′} or j = {j}^{″} \\ 0 & otherwise\end{matrix} ,$$

where antenna ports \tilde{p}_{j′} or {\tilde{p}_{j′}, \tilde{p}_{j″}} may be associated with PT-RS transmission; and r(m) is based on a chirp signal. More details on the chirp signal is given below.

The PSSCH PT-RS may be mapped to resource elements according to

$$[ \begin{matrix}{a}_{k , l}^{( {p}_{o} , μ )} \\ ⋮ \\ {a}_{k , l}^{( {p}_{ρ - 1} , μ )}\end{matrix} ] = {β}_{DMRS}^{PSSCH} W [ \begin{matrix}{r}^{( {\tilde{p}}_{0} )} ( 2 n + {k}^{′} ) \\ ⋮ \\ {r}^{( {\tilde{p}}_{v - 1} )} ( 2 n + {k}^{′} )\end{matrix} ] \\ k = 4 n + 2 {k}^{′} + Δ$$

when all the following conditions are fulfilled
l is within the OFDM symbols allocated for the PSSCH transmission;
resource element (k, l) is not used for sidelink CSI-RS, PSCCH, nor DM-RS associated with PSSCH;
k′ and Δ correspond to \tilde{p}₀, . . . , \tilde{p}ᵥ₋₁

In some examples, the precoding matrix W may be predetermined.

In some example, the IE DMRS-DownlinkConfig may be used to configure downlink demodulation reference signals for PDSCH. A field phaseTrackingRS may configure downlink PTRS. If the field is not configured, the UE may assume that downlink PT-RS are absent. In an example, the IE DMRS-UplinkConfig may be used to configure uplink demodulation reference signals for PUSCH. A field phaseTrackingRS may configure uplink PT-RS.

In some examples, an IE PTRS-DownlinkConfig may be used to configure downlink phase tracking reference signals (PT-RS). A field epre-Ratio may indicate energy per resource element (EPRE) ratio between PTRS and PDSCH. A field frequencyDensity may indicate presence and frequency density of DL PT-RS as a function of Scheduled bandwidth. If the field is absent, the UE may use K_PT-RS=2. A field maxNrofPorts may indicate the maximum number of DL PTRS ports. A field resourceElementOffset may indicate the subcarrier offset for DL PT-RS. A field timeDensity may indicate presence and time density of DL PT-RS as a function of MCS.

In some examples, the IE PTRS-UplinkConfig may be used to configure uplink Phase-Tracking-Reference-Signals (PT-RS). A field frequencyDensity may indicate presence and frequency density of UL PT-RS for CP-OFDM waveform as a function of scheduled BW. A field maxNrofPorts may indicate maximum number of UL PTRS ports for CP-OFDM. A field ptrs-Power may indicate uplink PTRS power boosting factor per PTRS port. A field resourceElementOffset may indicate the subcarrier offset for UL PTRS for CP-OFDM. A field sampleDensity may indicate sample density of PT-RS for DFT-s-OFDM, pre-DFT, indicating a set of thresholds T={NRBn, n=0, 1, 2, 3, 4}, that indicates dependency between presence of PT-RS and scheduled bandwidth and the values of X and K the UE should use depending on the scheduled bandwidth. A field timeDensity may indicate presence and time density of UL PT-RS for CP-OFDM waveform as a function of MCS. A field timeDensityTransformPrecoding may indicate time density (OFDM symbol level) of PT-RS for DFT-s-OFDM. A field transformPrecoderDisabled may indicate configuration of UL PTRS without transform precoder (with CP-OFDM). A field transformPrecoderEnabled may indicate configuration of UL PTRS with transform precoder (DFT-S-OFDM).

In some examples, the IE SL-ResourcePool may specify the configuration information for NR sidelink communication resource pool. The IE SL-ResourcePool may comprise a sl-PTRS-Config IE indicating parameters such as frequency density, time density and PT-RS resource element offset.

In some examples, when transform precoding is not enabled and if a UE is configured with the higher layer parameter phaseTrackingRS in DMRS-UplinkConfig, the higher layer parameters timeDensity and frequencyDensity in PTRS-UplinkConfig may indicate threshold values ptrs-MCSi, i=1, 2, 3 and NRB,i, i=0, 1 used in PT-RS sequence generation and/or mapping.

In some examples, when transform precoding is not enabled and if a UE is configured with the higher layer parameter phaseTrackingRS in DMRS-UplinkConfig, if either or both higher layer parameters timeDensity and/or frequencyDensity in PTRS-UplinkConfig are configured, the UE may assume the PT-RS antenna ports' presence and pattern are a function of the corresponding scheduled MCS and scheduled bandwidth in a corresponding bandwidth part. If the higher layer parameter timeDensity is not configured, the UE may assume LPT-RS=1. If the higher layer parameter frequencyDensity is not configured, the UE shall assume KPT-RS=2.

In some examples, when transform precoding is not enabled and if a UE is configured with the higher layer parameter phaseTrackingRS in DMRS-UplinkConfig, if none of the higher layer parameters timeDensity and frequencyDensity in PTRS-UplinkConfig are configured, the UE may assume LPT-RS=1 and KPT-RS=2.

In some examples, if the higher layer parameter PTRS-

UplinkConfig indicates that the time density thresholds ptrs-MCSi=ptrs-MCSi+1, then the time density LPTRS of the associated row may be disabled. If the higher layer parameter frequencyDensity in PTRS-UplinkConfig indicates that the frequency density thresholds NRB,i=NRB,i+1, then the frequency density KPTRS of the associated row may be disabled.

In some examples, if either or both of the parameters PT-RS time density (LPT-RS) and PT-RS frequency density (KPT-RS), indicates that are configured as ‘PT-RS not present’, the UE may assume that PT-RS is not present.

In some examples, when a UE is scheduled to transmit PUSCH with allocation duration of 2 symbols or less, and if LPT-RS is set to 2 or 4, the UE may not transmit PT-RS. When a UE is scheduled to transmit PUSCH with allocation duration of 4 symbols or less, and if LPT-RS is set to 4, the UE may not transmit PT-RS.

In some examples, the maximum number of configured PT-RS ports may be given by the higher layer parameter maxNrofPorts in PTRS-UplinkConfig. The UE may not be expected to be configured with a larger number of UL PT-RS ports than it has reported need for.

In some examples, if a UE has reported the capability of supporting full-coherent UL transmission, the UE may expect the number of UL PT-RS ports to be configured as one if UL-PTRS is configured.

In some examples, for codebook or non-codebook based UL transmission, the association between UL PT-RS port(s) and DM-RS port(s) may be signalled by PTRS-DMRS association field in DCI format 0_1 and DCI format 0_2. For a PUSCH corresponding to a configured grant Type 1 transmission, the UE may assume the association between UL PT-RS port(s) and DM-RS port(s) based on one or more tables.

In some examples, for PUSCH scheduled by DCI format 0_0 or by activation DCI format 0_0, the UL PT-RS port may be associated to DM-RS port 0.

In some examples, for non-codebook based UL transmission, the actual number of UL PT-RS port(s) to transmit may be determined based on SRI(s) in DCI format 0_1 and DCI format 0_2 or higher layer parameter sri-ResourceIndicator in rrc-ConfiguredUplinkGrant. A UE is configured with the PT-RS port index for each configured SRS resource by the higher layer parameter ptrs-PortIndex configured by SRS-Config if the UE is configured with the higher layer parameter phaseTrackingRS in DMRS-UplinkConfig. If the PT-RS port index associated with different SRIs are the same, the corresponding UL DM-RS ports may be associated to the one UL PT-RS port.

In some examples, when the UE is scheduled with Qp={1,2} PT-RS port(s) in uplink and the number of scheduled layers is n_{layer}^{PUSCH}, if the UE is configured with higher layer parameter ptrs-Power, the PUSCH to PT-RS power ratio per layer per RE ρ_{PTRS}^{PUSCH} may be given by ρ_{PTRS}^{PUSCH}=−α_{PTRS}^{PUSCH}[dB], where α_{PTRS}^{PUSCH} may be the higher layer parameter ptrs-Power, the PT-RS scaling factor β_{PTRS} may be given by

$${β}_{PTRS} = {10}^{- \frac{{ρ}_{PTRS}^{PUSCH}}{20}}$$

and also on the Precoding Information and Number of Layers field in DCI.

In some examples, when transform precoding is enabled and if a UE is configured with the higher layer parameter transformPrecoderEnabled in PTRS-UplinkConfig, the UE may be configured with the higher layer parameters sampleDensity and the UE may assume the PT-RS antenna ports' presence and PT-RS group pattern are a function of the corresponding scheduled bandwidth in a corresponding bandwidth part. The UE may assume no PT-RS is present when the number of scheduled RBs is less than NRB0 if NRB0>1 or if the RNTI equals TC-RNTI. The UE may be configured PT-RS time density LPT-RS=2 with the higher layer parameter timeDensityTransformPrecoding. Otherwise, the UE may assume LPT-RS=1.

In some examples, a PT-RS reception may be used by a UE receiving PDSCH scheduled by DCI format 1_2 configured with the higher layer parameter phaseTrackingRS in dmrs-DownlinkForPDSCH-MappingTypeA-ForDCI-Format1-2-r16 or dmrs-DownlinkForPDSCH-MappingTypeB-ForDCI-Format1-2-r16 and to a UE receiving PDSCH scheduled by DCI format 1_0 or DCI format 1_1 configured with the higher layer parameter phaseTrackingRS in dmrs-DownlinkForPDSCH-MappingTypeA or dmrs-DownlinkForPDSCH-MappingTypeB.

In some examples, a UE may report the preferred MCS and bandwidth thresholds based on the UE capability at a given carrier frequency, for each subcarrier spacing applicable to data channel at this carrier frequency, assuming the MCS table with the maximum Modulation Order as it reported to support.

In some examples, a UE may be configured with the higher layer parameter phaseTrackingRS in DMRS-DownlinkConfig. The higher layer parameters timeDensity and frequencyDensity in PTRS-DownlinkConfig may indicate the threshold values ptrs-MCSi, i=1, 2, 3 and NRB,i, i=0, 1.

In some examples, a UE may be configured with the higher layer parameter phaseTrackingRS in DMRS-DownlinkConfig. If either or both of the additional higher layer parameters timeDensity and frequencyDensity are configured, and the RNTI equals MCS-C-RNTI, C-RNTI or CS-RNTI, the UE may assume the PT-RS antenna port' presence and pattern is a function of the corresponding scheduled MCS of the corresponding codeword and scheduled bandwidth in corresponding bandwidth part. If the higher layer parameter timeDensity given by PTRS-DownlinkConfig is not configured, the UE may assume LPT-RS=1. If the higher layer parameter frequencyDensity given by PTRS-DownlinkConfig is not configured, the UE may assume KPT-RS=2.

In some examples, if a UE is not configured with the higher layer parameter phaseTrackingRS in DMRS-DownlinkConfig, the UE may assume PT-RS is not present.

In some examples, the higher layer parameter PTRS-DownlinkConfig may provide the parameters ptrs-MCSi, i=1, 2, 3.

In some examples, if the higher layer parameter PTRS-DownlinkConfig indicates that the time density thresholds ptrs-MCSi=ptrs-MCSi+1, then the time density LPT-RS of the associated may be disabled. If the higher layer parameter PTRS-DownlinkConfig indicates that the frequency density thresholds NRBi=NRBi+1, then the frequency density KPTRS of the associated row may be disabled.

In some examples, if either or both of the parameters PT-RS time density (LPT-RS) and PT-RS frequency density (KPT-RS) indicates that ‘PT-RS not present’, the UE may assume that PT-RS is not present.

In some examples, when the UE is receiving a PDSCH with allocation duration of 2 symbols and if LPT-RS is set to 2 or 4, the UE may assume PT-RS is not transmitted.

In some examples, when the UE is receiving a PDSCH with allocation duration of 4 symbols and if LPT-RS is set to 4, the UE may assume PT-RS is not transmitted.

In some examples, the DL DM-RS port(s) associated with a PT-RS port may be assumed to be quasi co-located with respect to {‘QCL-TypeA’ and ‘QCL-TypeD’}. If a UE is scheduled with one codeword, the PT-RS antenna port may be associated with the lowest indexed DM-RS antenna port among the DM-RS antenna ports assigned for the PDSCH.

In some examples, if a UE is scheduled with two codewords, the PT-RS antenna port may be associated with the lowest indexed DM-RS antenna port among the DM-RS antenna ports assigned for the codeword with the higher MCS. If the MCS indices of the two codewords are the same, the PT-RS antenna port may be associated with the lowest indexed DM-RS antenna port assigned for codeword 0.

In some examples, when a UE is not indicated with a DCI that DCI field “Time domain resource assignment’ indicating an entry which contains repetitionNumber-r16 in PDSCH-TimeDomainResourceAllocation-r16, and if the UE is configured with the higher layer parameter maxNrofPorts equal to n2, and if the UE is indicated with two TCI states by the codepoints of the DCI field ‘Transmission Configuration Indication’ and DM-RS port(s) within two CDM groups in the DCI field “Antenna Port(s)”, the UE may receive two PT-RS ports which may be associated to the lowest indexed DM-RS port among the DM-RS ports corresponding to the first/second indicated TCI state, respectively.

In some examples, when a UE configured by the higher layer parameter RepetitionScheme-r16 set to ‘FDMSchemeA’ or ‘FDMSchemeB’, and the UE is indicated with two TCI states in a codepoint of the DCI field ‘Transmission Configuration Indication and DM-RS port(s) within one CDM group in the DCI field “Antenna Port(s)”, the UE may receive a single PT-RS port which may be associated with the lowest indexed DM-RS antenna port among the DM-RS antenna ports assigned for the PDSCH, a PT-RS frequency density is determined by the number of PRBs associated to each TCI state, and a PT-RS resource element mapping may be associated to the allocated PRBs for each TCI state.

Phase tracking is important for the correct functioning of any wireless system. Even small disparities in the phase may lead to a degraded performance of the system as errors may increase. Phase errors may be described as small frequency discrepancies which may lead to delays between transmitter and receiver signals. In some examples, phase differences may occur because clocks of remote devices are not perfectly aligned. Even small differences in the frequency may translate into phases offsets, which may lead to higher bit error rates. The receiver may implement processes to counter phase differences. Example embodiments enhance the PT-RS signal generation in downlink, uplink and sidelink based on utilizing a chirp signal and enhance the phase tracking performance at the UE or base station.

In some examples, a chirp signal may be used for the Phase Tracking reference signal. The chirp signal may be demodulated with the same chirp signal. If there is no delay, the chirp signal may demodulate as a constant discrete component (DC) component. If there is a delay, there may be an actual frequency offset incurred by the delay which then may lead to a tone with a specific frequency. This frequency may be detected by the use of a fast frequency transform (FFT) process.

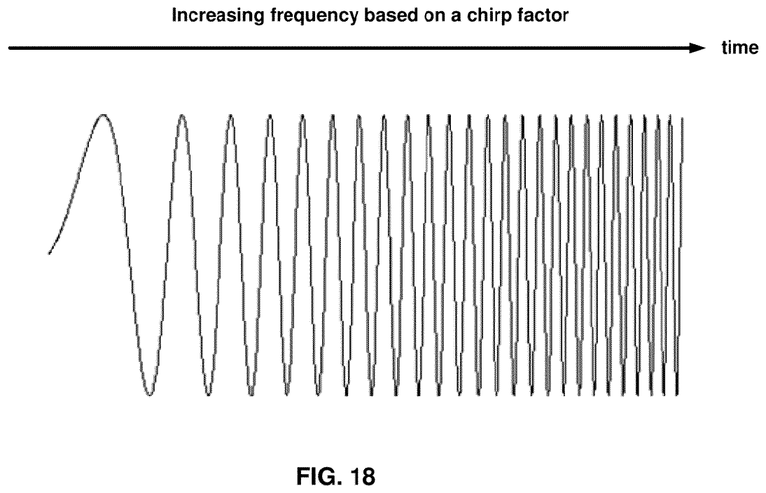

The frequency of the chirp signal may change over time. An example is shown in FIG. 18. The chirp signal may be formulated as c(t)=Ae^{-j(ω+δt)t}. The frequency of the signal increases over time based on the chirp factor δ. If the signal is demodulated with another signal with a small offset the amplitude of the demodulated signal changes which is an indication that there is an offset and may be used for compensating of the phase noise.

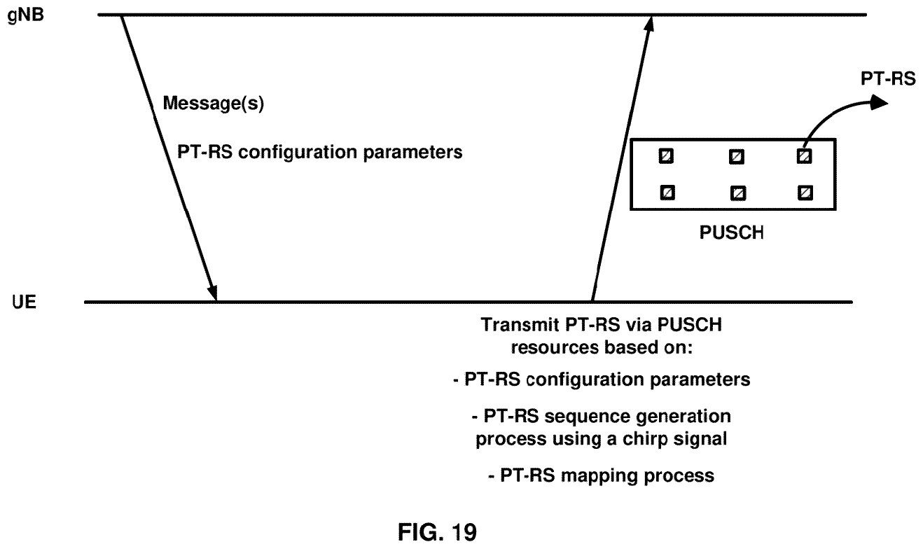

In an example embodiment as shown in FIG. 19, a UE may receive from a gNB one or more messages (e.g., one or more RRC messages) comprising configuration parameters. The configuration parameters may comprise uplink PT-RS configuration parameters. For example, the one or more messages may comprise a phase tracking reference signal (PT-RS) uplink config information element (e.g., PTRS-UplinkConfig IE) indicating the uplink PT-RS configuration parameters. The uplink PT-RS configuration parameters may be used by the UE for generation of PT-RS sequence and/or mapping of the PT-RS sequence to radio resources (e.g., resource elements within a PUSCH allocation). In an example, the UE may receive a DCI (e.g., a DCI format 0_0, DCI format 0_1 or DCI format 0_2) comprising an uplink grant indicating radio resources for transmission of an uplink TB via PUSCH. The PUSCH may be scheduled for transmission via a cell that is in a first frequency range/frequency band. For example, the cell may be in a FR2 frequency range (e.g., above 6 GHz). The UE may transmit the PT-RS signals via radio resources of PUSCH used for transmission of the uplink TB. The uplink PT-RS signals may be used by the gNB for compensation of an oscillator phase noise. The UE may transmit the PT-RS signals based on the PT-RS configuration parameters, a PT-RS sequence generation process used for generation of a PT-RS sequence and a PT-RS mapping process for mapping of the generated PT-RS sequence to the radio resources of the PUSCH allocated for transmission of the uplink TB. The PT-RS sequence generation may use the chirp signal described above according to a chirp factor (e.g., δ). In some examples the chirp factor may be indicated by an RRC parameter (e.g., based on the uplink PT-RS configuration parameters). In some examples, the chirp factor may be a predetermined value. In some example, a DCI (e.g., the DCI used for scheduling PUSCH/uplink TB) may indicate the chirp factor. For example, the DCI may comprise a field, a value of the field indicating the chirp factor. In some examples, the UE may receive a MAC CE indicating the chirp factor used for sequence generation of the PT-RS signal. The chirp signal may be associated with a time-varying frequency wherein the level of variation of the frequency may be dependent on the chirp factor. In some examples, the PT-RS sequence generation process may be different when transform precoding is enabled compared to when transform precoding is not enabled. For example, the UE may use a first sequence generation process when transform precoding is not enabled and may use a second sequence generation process when transform precoding is enabled. In some examples, both of the first process and the second process may be based on one or more chirp signals. The UE may map the generated PT-RS sequence to resource elements of the PUSCH and may transmit the PT-RS signal to the gNB via the PUSCH resources. The mapping process may comprise determining the subcarriers that the PT-RS signals are mapped to. In some examples, the mapping of the PT-RS signals to the PUSCH resources may be such that the PT-RS signals are sparser in the frequency domain compared to the time domain.

The generation and mapping of the PT-RS signals may be based on the uplink PT-RS configuration parameters. For example, the uplink PT-RS configuration parameters may comprise a frequency density parameter indicating presence and frequency density of the PT-RS as a function of a scheduled bandwidth of the physical uplink shared channel (PUSCH). The UE may determine the density of the PT-RS signals in the frequency domain and accordingly map the PT-RS signals to the PUSCH resources based on the frequency density parameter. For example, the uplink PT-RS configuration parameters may comprise a parameter (e.g., maxNrofPorts) indicating maximum number of uplink PT-RS ports. The UE may use the value of this parameter for transmission of the PT-RS signals. For example, the uplink PT-RS configuration parameters may comprise a parameter indicating an uplink PT-RS boosting factor per PT-RS port, e.g., for determining the PUSCH to PT-RS power ratio and determination of the PT-RS power. For example, the uplink PT-RS configuration parameters may comprise resource element offset parameter indicating a subcarrier offset for uplink PT-RS which may be used in the PT-RS mapping process. For example, the uplink PT-RS configuration parameters may comprise a sample density parameter indicating sample density of PT-RS for discrete frequency transform (DFT) spread orthogonal frequency division multiplexing (OFDM), pre-DFT, indicating a set of thresholds that indicates dependency between presence of PT-RS and scheduled bandwidth of the physical uplink shared channel (PUSCH). For example, the uplink PT-RS configuration parameters may comprise a time density parameter indicating presence and time density of the PT-RS as a function of modulation and coding scheme (MCS). The UE may determine the density of the PT-RS signals in the time domain and accordingly map the PT-RS signals to the PUSCH resources based on the time density parameter. For example, the uplink PT-RS configuration parameters may comprise a time density transform precoding parameter indicating a time density of PT-RS for discrete frequency transform spread orthogonal frequency division multiplexing (DFT-s-OFDM) in an OFDM symbol level. For example, the uplink phase tracking reference signal (PT-RS) configuration parameters comprise one or more parameters indicating whether the uplink PT-RS is configured with a cyclic prefix orthogonal frequency division multiplexing (CP-OFDM) waveform or a discrete frequency transform spread orthogonal frequency division multiplexing (DFT-s-OFDM) waveform.

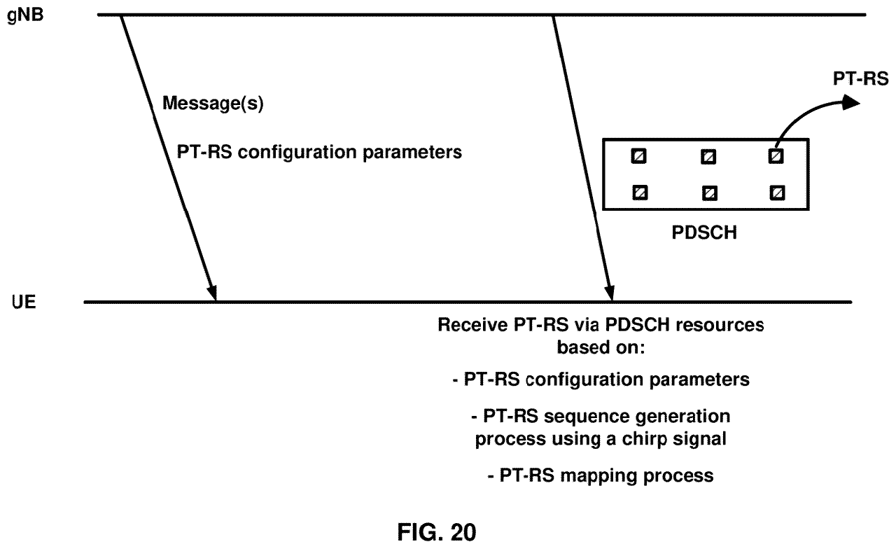

In an example embodiment as shown in FIG. 20, a UE may receive from a gNB one or more messages (e.g., one or more RRC messages) comprising configuration parameters. The configuration parameters may comprise downlink PT-RS configuration parameters. For example, the one or more messages may comprise a phase tracking reference signal (PT-RS) downlink config information element (e.g., PTRS-DownlinkConfig IE) indicating the downlink PT-RS configuration parameters. The downlink PT-RS configuration parameters may be used by the UE for receiving/detecting PT-RS sequence and/or the mapping of the PT-RS sequence to radio resources (e.g., resource elements within a PDSCH allocation). In an example, the UE may receive a DCI (e.g., a DCI format 1_0, DCI format 1_1 or DCI format 1_2) comprising an downlink assignment indicating radio resources for reception of a downlink TB via PDSCH. The PDSCH may be scheduled for reception of the downlink TB via a cell that is in a first frequency range/frequency band. For example, the cell may be in a FR2 frequency range (e.g., above 6 GHz). The UE may receive the PT-RS signals via radio resources of PDSCH used for reception of the downlink TB. The UE may compensate for an oscillator phase noise based on the received downlink PT-RS signals. In some examples, the UE may perform one or more of time and frequency tracking, estimation of delay spread and estimation of Doppler spread based on the received PT-RS signals. The UE may receive the PT-RS signals based on the PT-RS configuration parameters, a PT-RS sequence generation process used for generation of a PT-RS sequence and a PT-RS mapping process for mapping of the generated PT-RS sequence to the radio resources of the PDSCH allocated for transmission of the downlink TB. The PT-RS sequence generation may use the chirp signal described above according to a chirp factor (e.g., δ). In some examples the chirp factor may be indicated by an RRC parameter (e.g., based on the downlink PT-RS configuration parameters). In some examples, the chirp factor may be a predetermined value. In some example, a DCI (e.g., the DCI used for scheduling PDSCH/downlink TB) may indicate the chirp factor. For example, the DCI may comprise a field, a value of the field indicating the chirp factor. In some examples, the UE may receive a MAC CE indicating the chirp factor used for sequence generation of the PT-RS signal. The chirp signal may be associated with a time-varying frequency wherein the level of variation of the frequency may be dependent on the chirp factor. The generated PT-RS sequence may be mapped to resource elements of the PDSCH. The gNB may transmit the PT-RS signals to the UE via the PDSCH resources. The mapping process may comprise determining the subcarriers that the PT-RS signals are mapped to. In some examples, the mapping of the PT-RS signals to the PDSCH resources may be such that the PT-RS signals are sparser in the frequency domain compared to the time domain.

The generation, mapping and transmission of the PT-RS signals, by the gNB to the UE, may be based on the downlink PT-RS configuration parameters. For example, the downlink PT-RS configuration parameters may comprise an energy per resource element (EPRE) ratio parameter indicating an EPRE ratio between the PT-RS and the physical downlink shared channel (PDSCH). For example, the downlink PT-RS configuration parameters may comprise a frequency density parameter indicating presence and frequency density of the PT-RS as a function of a scheduled bandwidth of the physical downlink shared channel (PDSCH). The UE may determine the density of the PT-RS signals in the frequency domain and accordingly determine the mapping of the PT-RS signals to the PDSCH resources based on the frequency density parameter. For example, the downlink PT-RS configuration parameters may comprise a parameter (e.g., maxNrofPorts) indicating maximum number of downlink PT-RS ports. The UE may use the value of this parameter for reception of the PT-RS signals. For example, the downlink PT-RS configuration parameters may comprise resource element offset parameter indicating a subcarrier offset for downlink PT-RS which may be used in the PT-RS mapping process. For example, the downlink PT-RS configuration parameters may comprise a time density parameter indicating presence and time density of the PT-RS as a function of modulation and coding scheme (MCS). The UE may determine the density of the PT-RS signals in the time domain and accordingly determine the mapping the PT-RS signals to the PDSCH resources based on the time density parameter.

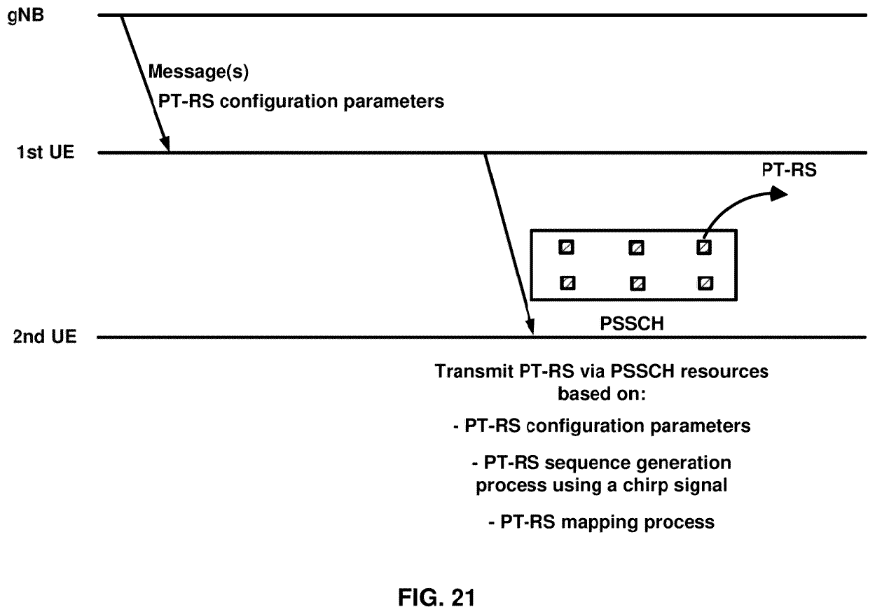

In an example embodiment as shown in FIG. 21, a first UE may receive from a gNB one or more messages (e.g., one or more RRC messages) comprising configuration parameters. The configuration parameters may comprise sidelink PT-RS configuration parameters. For example, the one or more messages may comprise a phase tracking reference signal (PT-RS) sidelink config information element (e.g., PTRS-SidelinkConfig IE) indicating the sidelink PT-RS configuration parameters. The sidelink PT-RS configuration parameters may be used by the first UE for generation of PT-RS sequence and/or mapping of the PT-RS sequence to radio resources (e.g., resource elements within a PSSCH allocation). In an example, the first UE may receive a DCI (e.g., a DCI format 3_0 or DCI format 3_1) comprising scheduling information indicating radio resources for transmission of a sidelink TB via PSSCH. The PSSCH may be scheduled for transmission via a cell configured with sidelink communications (e.g., configured with a sidelink resource pool). The first UE may transmit the PT-RS signals via radio resources of PSSCH used for transmission of the sidelink TB. The sidelink PT-RS signals, received by the second UE from the first UE, may be used by the second UE for compensation of an oscillator phase noise. In some examples, the second UE may perform one or more of time and frequency tracking, estimation of delay spread, and estimation of Doppler spread based on the received PT-RS signals from the first UE. The first UE may transmit the PT-RS signals based on the PT-RS configuration parameters, a PT-RS sequence generation process used for generation of a PT-RS sequence and a PT-RS mapping process for mapping of the generated PT-RS sequence to the radio resources of the PSSCH allocated for transmission of the sidelink TB. The PT-RS sequence generation may use the chirp signal described above according to a chirp factor (e.g., δ). In some examples the chirp factor may be indicated by an RRC parameter (e.g., based on the uplink PT-RS configuration parameters). In some examples, the chirp factor may be a predetermined value. In some example, a DCI (e.g., the DCI used for scheduling PSSCH/sidelink TB) may indicate the chirp factor. For example, the DCI may comprise a field, a value of the field indicating the chirp factor. In some examples, the UE may receive a MAC CE indicating the chirp factor used for sequence generation of the PT-RS signal. The chirp signal may be associated with a time-varying frequency wherein the level of variation of the frequency may be dependent on the chirp factor. The first UE may map the generated PT-RS sequence to resource elements of the PUSCH and may transmit the PT-RS signal to a second UE via the PSSCH resources. The mapping process may comprise determining the subcarriers that the PT-RS signals are mapped to. In some examples, the mapping of the PT-RS signals to the PSSCH resources may be such that the PT-RS signals are sparser in the frequency domain compared to the time domain.

The generation and mapping of the PT-RS signals may be based on the sidelink PT-RS configuration parameters. For example, the sidelink PT-RS configuration parameters may comprise a frequency density parameter indicating presence and frequency density of the PT-RS as a function of a scheduled bandwidth of the physical sidelink shared channel (PSSCH). The first UE may determine the density of the PT-RS signals in the frequency domain and accordingly map the PT-RS signals to the PSSCH resources based on the frequency density parameter. For example, the sidelink PT-RS configuration parameters may comprise resource element offset parameter indicating a subcarrier offset for sidelink PT-RS which may be used in the PT-RS mapping process. For example, the sidelink PT-RS configuration parameters may comprise a time density parameter indicating presence and time density of the PT-RS as a function of modulation and coding scheme (MCS). The first UE may determine the density of the PT-RS signals in the time domain and accordingly map the PT-RS signals to the PSSCH resources based on the time density parameter.

In an embodiment, a user equipment (UE) may receive, from a base station (BS), one or more messages comprising uplink PT-RS configuration parameters. The UE may transmit, to the BS, PT-RS signals via radio resources of a physical uplink shared channel (PUSCH) based on: the uplink PT-RS configuration parameters; a PT-RS sequence generation process for generating a PT-RS sequence, wherein the PT-RS sequence is based on a chirp signal with a time-varying frequency according to a chirp factor; and a PT-RS mapping process for mapping the generated PT-RS sequence to the radio resources of the PUSCH.

In some embodiments, the uplink phase tracking reference signal (PT-RS) configuration parameters may comprise a first parameter indicating the chirp factor.

In some embodiments, the chirp factor may be a predetermined value.

In some embodiments, the UE may receive a downlink control information comprising a field with a value indicating the chirp factor.

In some embodiments, the UE may receive a medium access control (MAC) control element (CE) indicating the chirp factor.

In some embodiments, the one or more messages may comprise a phase tracking reference signal (PT-RS) uplink config information element indicating the uplink PT-RS configuration parameters.

In some embodiments, the uplink phase tracking reference signal (PT-RS) configuration parameters may comprise a frequency density parameter indicating presence and frequency density of the PT-RS as a function of a scheduled bandwidth of the physical uplink shared channel (PUSCH).

In some embodiments, the uplink phase tracking reference signal (PT-RS) configuration parameters may comprise a parameter indicating maximum number of uplink PT-RS ports.

In some embodiments, the uplink phase tracking reference signal (PT-RS) configuration parameters may comprise a parameter indicating an uplink PT-RS boosting factor per PT-RS port.

In some embodiments, the uplink phase tracking reference signal (PT-RS) configuration parameters may comprise a resource element offset parameter indicating a subcarrier offset for uplink PT-RS.

In some embodiments, the uplink phase tracking reference signal (PT-RS) configuration parameters may comprise a sample density parameter indicating sample density of PT-RS for discrete frequency transform (DFT) spread orthogonal frequency division multiplexing (OFDM), pre-DFT, indicating a set of thresholds that indicates dependency between presence of PT-RS and scheduled bandwidth of the physical uplink shared channel (PUSCH).

In some embodiments, the uplink phase tracking reference signal (PT-RS) configuration parameters may comprise a time density parameter indicating presence and time density of the PT-RS as a function of modulation and coding scheme (MCS).

In some embodiments, the uplink phase tracking reference signal (PT-RS) configuration parameters may comprise a time density transform precoding parameter indicating a time density of PT-RS for discrete frequency transform spread orthogonal frequency division multiplexing (DFT-s-OFDM) in an OFDM symbol level.

In some embodiments, the uplink phase tracking reference signal (PT-RS) configuration parameters may comprise one or more parameters indicating whether the uplink PT-RS is configured with a cyclic prefix orthogonal frequency division multiplexing (CP-OFDM) waveform or a discrete frequency transform spread orthogonal frequency division multiplexing (DFT-s-OFDM) waveform.

In some embodiments, the PT-RS signals may be used for compensation of an oscillator phase noise.

In some embodiments, the radio resources of the physical uplink shared channel (PUSCH) may be associated with a cell in frequency range 2 (FR2).

In some embodiments, the UE may receive a downlink control information comprising an uplink grant indicating the radio resources of the physical uplink shared channel (PUSCH) for transmission of an uplink transport block. In some embodiments, the downlink control information (DCI) may be one of DCI format 0_0, DCI format 0_1 and DCI format 0_2.

In some embodiments, a first density of the PT-RS signals in the frequency domain may be sparser than a second density of the PTR-RS signals in the time domain.

In some embodiments, the phase tracking reference signal (PT-RS) sequence generation process may comprise generating the PT-RS sequence based on a first process if transform precoding is not enabled and based on a second process if transform precoding is enabled.

In some embodiments, the phase tracking reference signal (PT-RS) sequence generation process may comprise generating values of the PT-RS sequence for different subcarriers that the PT-RS sequence is mapped to.

In some embodiments, the phase tracking reference signal (PT-RS) mapping process may comprise mapping the generated PT-RS sequence to different resource elements within the radio resources of a physical uplink shared channel (PUSCH).

In an embodiment, a user equipment (UE) may receive, from a base station (BS), one or more messages comprising downlink PT-RS configuration parameters. The UE may receive, from the BS, PT-RS signals via radio resources of a physical downlink shared channel (PDSCH) based on: the downlink PT-RS configuration parameters; a PT-RS sequence generation process for generating a PT-RS sequence, wherein the PT-RS sequence is based on a chirp signal with a time-varying frequency according to a chirp factor; and a PT-RS mapping process for mapping the generated PT-RS sequence to the radio resources of the PDSCH.

In some embodiments, the downlink phase tracking reference signal (PT-RS) configuration parameters may comprise a first parameter indicating the chirp factor.

In some embodiments, the chirp factor may be a predetermined value.

In some embodiments, the UE may receive a downlink control

information comprising a field with a value indicating the chirp factor.

In some embodiments, the UE may receive a medium access control (MAC) control element (CE) indicating the chirp factor.

In some embodiments, the one or more messages may comprise a PT-RS downlink config information element indicating the PT-RS configuration parameters.

In some embodiments, the downlink phase tracking reference signal (PT-RS) configuration parameters may comprise an energy per resource element (EPRE) ratio parameter indicating an EPRE ratio between the PT-RS and the physical downlink shared channel (PDSCH).

In some embodiments, the downlink phase tracking reference signal (PT-RS) configuration parameters may comprise a frequency density parameter indicating presence and frequency density of the PT-RS as a function of scheduled bandwidth of the physical downlink shared channel (PDSCH).

In some embodiments, the downlink phase tracking reference signal (PT-RS) configuration parameters may comprise a parameter indicating maximum number of downlink PT-RS ports.

In some embodiments, the downlink phase tracking reference signal (PT-RS) configuration parameters may comprise a resource element offset parameter indicating a subcarrier offset for downlink PT-RS.

In some embodiments, the downlink phase tracking reference signal (PT-RS) configuration parameters may comprise a time density parameter indicating presence and time density of downlink PT-RS as a function of MCS.

In some embodiments, the UE may compensate for an oscillator phase noise based on the received phase tracking reference signal (PT-RS) signals.

In some embodiments, the radio resources of the physical downlink shared channel (PDSCH) may be associated with a cell in frequency range 2 (FR2).

In some embodiments, the UE may perform, based on the received phase tracking reference signal (PT-RS) signals, at least one of: time and frequency tracking; estimation of a delay spread; and estimation of a doppler spread.

In some embodiments, the UE may receive a downlink control information comprising a downlink assignment indicating the radio resources of the physical downlink shared channel (PDSCH) for reception of a downlink transport block. In some embodiments, the downlink control information (DCI) may be one of DCI format 1_0, DCI format 1_1 and DCI format 1_2.

In some embodiments, a first density of the PT-RS signals in the frequency domain may be sparser than a second density of the PTR-RS signals in the time domain.

In some embodiments, the phase tracking reference signal (PT-RS) sequence generation process may comprise generating values of the PT-RS sequence for different subcarriers that the PT-RS sequence is mapped to.

In some embodiments, the phase tracking reference signal (PT-RS) mapping process may comprise mapping the generated PT-RS sequence to different resource elements within the radio resources of a physical downlink shared channel (PDSCH).

In an embodiment, a first user equipment (UE) may receive from a base station, one or more messages comprising sidelink PT-RS configuration parameters. The first UE may transmit to a second UE, PT-RS signals via radio resources of a physical sidelink shared channel (PSSCH) based on: the sidelink PT-RS configuration parameters; a PT-RS sequence generation process for generating a PT-RS sequence, wherein the PT-RS sequence is based on a chirp signal with a time-varying frequency according to a chirp factor; and a PT-RS mapping process for mapping the generated PT-RS sequence to the radio resources of the PSSCH.

In some embodiments, the sidelink phase tracking reference signal (PT-RS) configuration parameters may comprise a first parameter indicating the chirp factor.

In some embodiments, the chirp factor may be a predetermined value.

In some embodiments, the first UE and/or the second UE may receive a downlink control information comprising a field with a value indicating the chirp factor.

In some embodiments, the first UE and/or the second UE may receive a medium access control (MAC) control element (CE) indicating the chirp factor.

In some embodiments, the one or more messages may comprise a phase tracking reference signal (PT-RS) sidelink config information element indicating the sidelink PT-RS configuration parameters.

In some embodiments, the sidelink phase tracking reference signal (PT-RS) configuration parameters may comprise a frequency density parameter indicating presence and frequency density of the PT-RS as a function of scheduled bandwidth of the physical sidelink shared channel (PSSCH).

In some embodiments, the sidelink phase tracking reference signal (PT-RS) configuration parameters may comprise a resource element offset parameter indicating a subcarrier offset for sidelink PT-RS.

In some embodiments, the sidelink phase tracking reference signal (PT-RS) configuration parameters may comprise a time density parameter indicating presence and time density of sidelink PT-RS as a function of MCS.

In some embodiments, the PT-RS signals may be used for compensating an oscillator phase noise by the second user equipment (UE).

In some embodiments, the phase tracking reference signal (PT-RS) signals may be used for at least one of: time and frequency tracking; estimation of a delay spread; and estimation of a doppler spread.

In some embodiments, the first UE may receive a downlink control information comprising sidelink scheduling parameters indicating the radio resources of the physical downlink shared channel (PSSCH) for transmission of a sidelink transport block. In some embodiments, the downlink control information (DCI) may be one of a DCI format 3_0 and DCI format 3_1.

In some embodiments, a first density of the PT-RS signals in the frequency domain may be sparser than a second density of the PTR-RS signals in the time domain.

In some embodiments, the phase tracking reference signal (PT-RS) sequence generation process may comprise generating values of the PT-RS sequence for different subcarriers that the PT-RS sequence is mapped to.

In some embodiments, the phase tracking reference signal (PT-RS) mapping process may comprise mapping the generated PT-RS sequence to different resource elements within the radio resources of a physical sidelink shared channel (PSSCH).

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of phase tracking reference signal (PT-RS) signals transmission, comprising the steps of:
receiving, by a user equipment (UE) from a base station (BS), one or more messages comprising uplink PT-RS configuration parameters; and
transmitting, by the UE to the BS, PT-RS signals via radio resources of a physical uplink shared channel (PUSCH) based on:
the uplink PT-RS configuration parameters;
a PT-RS sequence generation process for generating a PT-RS sequence, wherein the PT-RS sequence is based on a chirp signal with a time-varying frequency according to a chirp factor; and
a PT-RS mapping process for mapping the generated PT-RS sequence to the radio resources of the PUSCH.

2-5. (canceled)

6. The method of claim 1, wherein the one or more received messages comprise a phase tracking reference signal (PT-RS) uplink config information element defining the uplink PT-RS configuration parameters.

7. The method of claim 1, wherein the uplink phase tracking reference signal (PT-RS) configuration parameters comprise a frequency density parameter that defines a presence and frequency density of the PT-RS as a function of a scheduled bandwidth of the physical uplink shared channel (PUSCH).

8. The method of claim 1, wherein the uplink phase tracking reference signal (PT-RS) configuration parameters comprise a parameter defining a maximum number of uplink PT-RS ports.

9. The method of claim 1, wherein the uplink phase tracking reference signal (PT-RS) configuration parameters comprise a parameter indicating an uplink PT-RS boosting factor per PT-RS port.

10. The method of claim 1, wherein the uplink phase tracking reference signal (PT-RS) configuration parameters comprise a resource element offset parameter defining a subcarrier offset for uplink PT-RS.

11. The method of claim 1, wherein the uplink phase tracking reference signal (PT-RS) configuration parameters comprise a sample density parameter defining sample density of PT-RS for discrete frequency transform (DFT) spread orthogonal frequency division multiplexing (OFDM), pre-DFT, defining a set of thresholds that indicate dependency between presence of PT-RS and scheduled bandwidth of the physical uplink shared channel (PUSCH).

12. The method of claim 1, wherein the uplink phase tracking reference signal (PT-RS) configuration parameters comprise a time density parameter defining a presence and time density of the PT-RS as a function of modulation and coding scheme (MCS).

13. The method of claim 1, wherein the uplink phase tracking reference signal (PT-RS) configuration parameters comprise a time density transform precoding parameter defining a time density of PT-RS for discrete frequency transform spread orthogonal frequency division multiplexing (DFT-s-OFDM) in an OFDM symbol level.

14. The method of claim 1, wherein the uplink phase tracking reference signal (PT-RS) configuration parameters comprise one or more parameters defining whether the uplink PT-RS is configured with a cyclic prefix orthogonal frequency division multiplexing (CP-OFDM) waveform or a discrete frequency transform spread orthogonal frequency division multiplexing (DFT-s-OFDM) waveform.

15. (canceled)

16. The method of claim 1, wherein the radio resources of the physical uplink shared channel (PUSCH) are associated with a cell in frequency range 2 (FR2).

17. The method of claim 1, further comprising receiving a downlink control information (DCI) comprising an uplink grant defining the radio resources of the physical uplink shared channel (PUSCH) for transmission of an uplink transport block.

18. (canceled)

19. The method of claim 1, wherein a first density of the PT-RS signals in the frequency domain is sparser than a second density of the PTR-RS signals in the time domain.

20. The method of claim 1, wherein the phase tracking reference signal (PT-RS) sequence generation process comprises generating the PT-RS sequence based on a first process if transform precoding is not enabled and based on a second process if transform precoding is enabled.

21. The method of claim 1, wherein the phase tracking reference signal (PT-RS) sequence generation process comprises generating values of the PT-RS sequence for different subcarriers that the PT-RS sequence is mapped to.

22. The method of claim 1, wherein the phase tracking reference signal (PT-RS) mapping process comprises mapping the generated PT-RS sequence to different resource elements within the radio resources of a physical uplink shared channel (PUSCH).

23. A method of phase tracking reference signal (PT-RS) signals reception comprising the steps of:
receiving, by a user equipment (UE) from a base station (BS), one or more messages comprising downlink PT-RS configuration parameters; and
receiving, by the UE from the BS, PT-RS signals via radio resources of a physical downlink shared channel (PDSCH) based on:
the downlink PT-RS configuration parameters;
a PT-RS sequence generation process for generating a PT-RS sequence, wherein the PT-RS sequence is based on a chirp signal with a time-varying frequency according to a chirp factor; and
a PT-RS mapping process for mapping the generated PT-RS sequence to the radio resources of the PDSCH.

24-28. (canceled)

29. The method of claim 23, wherein the downlink phase tracking reference signal (PT-RS) configuration parameters comprise an energy per resource element (EPRE) ratio parameter defining an EPRE ratio between the PT-RS and the physical downlink shared channel (PDSCH).

30-35. (canceled)

36. The method of claim 23, further comprising performing, based on the received phase tracking reference signal (PT-RS) signals, at least one of:
time and frequency tracking;
estimation of a delay spread; and
estimation of a Doppler spread.

37-41. (canceled)

42. A method of phase tracking reference signal (PT-RS) signals transmission, comprising the steps of:
receiving, by a first user equipment (UE) from a base station, one or more messages comprising sidelink PT-RS configuration parameters; and
transmitting, by the first UE to a second UE, PT-RS signals via radio resources of a physical sidelink shared channel (PSSCH) based on:
the sidelink PT-RS configuration parameters;
a PT-RS sequence generation process for generating a PT-RS sequence, wherein the PT-RS sequence is based on a chirp signal with a time-varying frequency according to a chirp factor; and
a PT-RS mapping process for mapping the generated PT-RS sequence to the radio resources of the PSSCH.

43-57. (canceled)
